(19) United States
(12) Patent Application Publication
(10) Pub. No.: US 2004/0247248 A1
(43) Pub. Date: Dec. 9, 2004

(54) Passive alignment between waveguides and optical components

(76) Inventor: Stephen James Fasham, Bedfordshire (GB)

Correspondence Address: Myers Dawes, Andras & Sherman, 11th Floor, 19900 MacArthur Boulevard, Irvine, CA, 92612, US

(21) Appl. No.: 10/490,290

(22) PCT Filed: Sep. 19, 2002
(86) PCT No.: PCT/GB02/04283

(30) Foreign Application Priority Data
Sep. 21, 2001 (GB) 0122792.5

(51) Int. Cl. G02B 6/42

(52) U.S. Cl. 385/52; 385/50

(57) ABSTRACT

An optical coupling between an optical component (9), e.g. a light source, and a waveguide, such as a silica on silicon waveguide, the waveguide comprising a core (3) and cladding layer (4) of a first material (SiO [symbol] 2?) supported on a first s of a second material (Si), the core (3) being spaced from the first substrate (1) by a known distance, wherein recesses (5) are formed through the cladding layer (4) to the first substrate (1) and the optical component (9) comprises, or is mounted on a second substrate (7) which comprises, projections (8) of known length, each projection (8) being located in contact with the first substrate (1) within a respective recess (5) so that the optical component (9) is positioned in a known location relative to the first substrate (1) and hence to the waveguide core (3).

### TECHNICAL FIELD

This invention relates to a coupling between an optical component and an optical waveguide and, in particular, a silica on silicon waveguide and to a method of forming such a coupling.

### BACKGROUND ART

Complex optical devices may be produced from a number of separate components all of which have waveguiding functionality. These devices may be active, e.g. individual lasers and semiconductor optical amplifiers, or arrays of lasers and amplifiers, or passive, e.g. waveguide splitters and arrayed waveguide gratings (AWGs). In all cases, it is necessary to achieve good coupling between the optical modes in the individual components to form a device with acceptable insertion losses. Typically, the alignment accuracy required between the components is of the order of 1 micron in axes other than the optical axis and between 1 and 10 microns in the optical axis, provided the components have means (e.g. a taper structure) for matching the mode fields therein. Without mode matching, alignment tolerances are typically of the order of 0.1 microns. To date, when one of the components to be aligned is a silica on silicon waveguide, this level of alignment precision has only been possible using active techniques which manipulate the two devices in 2 or more (up to 6) axes whilst measuring the coupling between the components. Active alignment is, however, costly both in terms of the equipment required and the time taken for assembly.

The present invention aims to remove or reduce the need for active alignment between such components.

### SUMMARY OF INVENTION

According to a first aspect of the present invention, there is provided an optical coupling between an optical component and a waveguide, the waveguide comprising a core and cladding layer of a first material supported on a first substrate of a second material, the core being spaced from the first substrate by a known distance, wherein one or more recesses are formed through the cladding layer to the first substrate and the optical component comprises, or is mounted on a second substrate which comprises, one or more projections of known length, each projection being located in contact with the first substrate within a respective recess so that the optical component is positioned in a known location relative to the first substrate and hence to the waveguide core.

According to a further aspect of the invention there is provided a method of coupling an optical component with a waveguide, comprising the steps of:

fabricating a waveguide comprising a core and a cladding layer of a first material supported on a first substrate of a second material, the core being spaced from the first substrate by a known distance,

forming one or more recesses through the cladding layer to the first substrate;

fabricating an optical component, or a second substrate on which the component is or is to be mounted, with one or more projections of known length; and

locating each projection in contact with the first substrate within a respective recess so the optical component, or the second substrate, is positioned in a known location relative to the first substrate and hence to the waveguide core.

Preferred and optional features of the invention will be apparent from the following description and from the subsidiary claims of the specification.

### BRIEF DESCRIPTION OF DRAWINGS

The invention will now be further described, merely by way of example, with reference to the accompanying drawings, in which:

FIG. 1 shows a cross-section of a typical, known silica waveguide on a silicon wafer substrate;

FIG. 2 shows a cross-section of a modified waveguide component used in a preferred embodiment of the invention;

FIG. 3 shows the modified waveguide of FIG. 2 mounted to a support substrate on which an optical component (not shown) is to be mounted according to an embodiment of the invention;

FIG. 4 shows a cross-section of the arrangement shown in FIG. 3 taken along the optic axis of the waveguide, with an optical component mounted on the support substrate and thus optically coupled with the waveguide;

FIGS. 5A and 5B show views from one end and beneath of a support substrate such as that shown in FIG. 3;

FIG. 6A shows a cross-section similar to that of FIG. 2 of another form of waveguide component; and

FIG. 6B shows a view from beneath, similar to that of FIG. 5B, of another form of support substrate with an optical component (in this case a waveguide) formed thereon.

### BEST MODE OF INVENTION

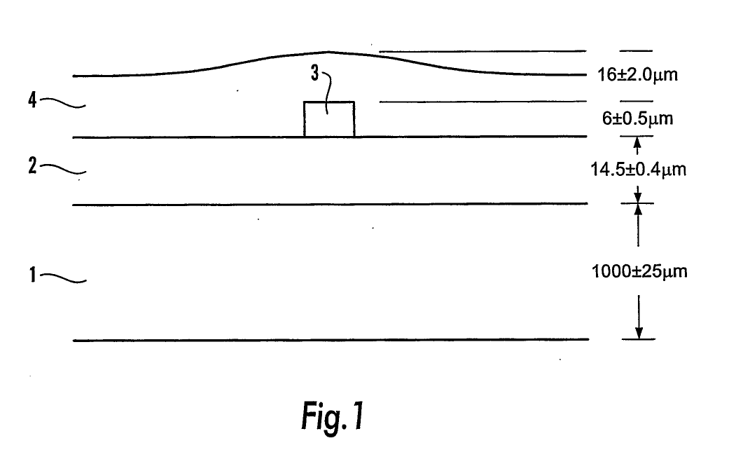

FIG. 1 shows a waveguide component comprising a silicon substrate 1, a thermal oxide layer 2 on the substrate 1, a silica waveguide core 3 and a silica cladding layer 4 over the core 3. The Figure shows typical dimensions and tolerances for each layer. The tolerances are dependent on the manufacturing method and the starting material. In the case of the cladding layer 4, the tolerance is affected by the underlying waveguide topography and as a result it is not possible to reduce this tolerance without developing a new method of depositing the cladding layer 4 which does not exhibit this dependence. The tolerance on both the core 3 dimension and the thermal oxide layer 2 can be improved by tightening process controls but are fundamentally limited by the accuracy of the equipment used to produce them. Given the typical tolerances, the position of the waveguide core 3 can not be defined to a positional tolerance of less than 2 microns from the top surface of the component. The tolerance on the overall thickness is also process dependent and the figures given in the diagram are typical for a commercially available wafer. This tolerance can be tightened to ˜10 □m by improving process controls, but further reductions would require the introduction of further processes such as chemo-mechanical polishing. The typical tolerance achieved using the top surface of the silica on silicon component as a reference surface is thus of the order of several microns, and is an order of magnitude worse if the backside of a standard Si substrate 1 is used as a reference.

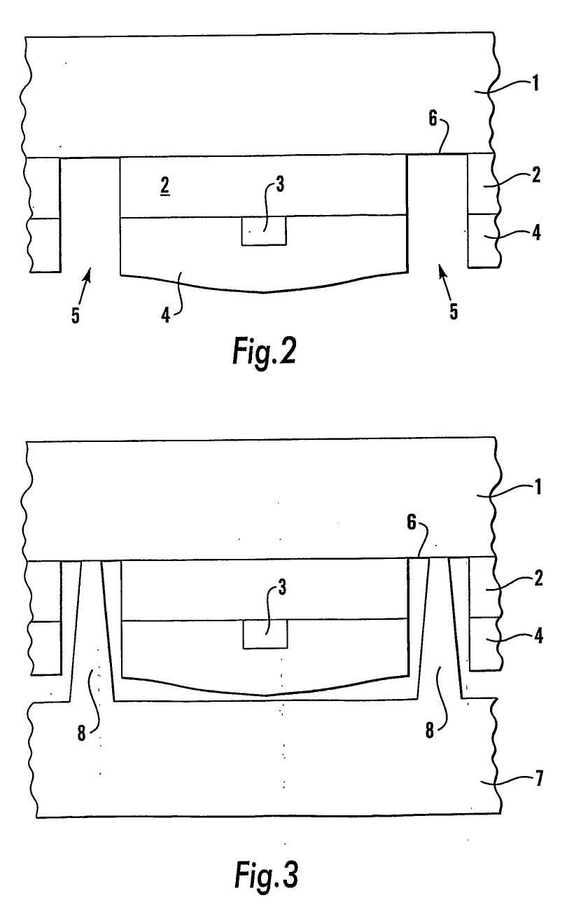

FIG. 2 shows a similar waveguide (but inverted) with recesses 5 etched through the cladding layer 4 and the oxide layer 2 to the interface 6 between the oxide layer 2 and the silicon substrate 1. The silicon substrate 1 acts as an etch stop so the bottom of the recess 5 is accurately determined by the interface 6. As indicated above, the position of the waveguide core 3 relative to the interface 6 can be known with sub-micron accuracy, as it is dependent only on the tolerances of the core 3 and thermal oxide layer 2 which can be tightly controlled. The interface 6 thus provides an accurate reference plane.

In order to use passive alignment techniques to couple optical components with mode fields of a size comparable to that of a single mode optical fibre, the components must be aligned with an accuracy better than 1 micron in order to achieve acceptable coupling loss (e.g. <3 dB). The positional accuracy of the centre of the optical mode within the core 3 relative to the interface 6 is a function of the manufacturing tolerance of the thermal oxide layer 2 (typically +/−0.4 microns) and the accuracy of the core 3 thickness (typically +/−0.5 microns). This is significantly more accurate than a point of reference on the external surface of the silica on silicon waveguide component shown in FIG. 1 and is sufficient to allow passive alignment to other devices (active or passive) with mode field diameters comparable to that of single mode optical fibre.

FIG. 3 shows the waveguide of FIG. 2 and a support substrate in the form of a further wafer 7 on which an optical component (not shown), such as a laser diode or an amplifier, can be mounted. Projections 8 of known length (perpendicular to the plane of the wafer 7) are formed on the wafer 7 (or on the optical component) and the wafer 7 is mounted with the projections 8 located within the recesses 5 in contact with the interface 6 so the optical component is positioned in an accurately known location relative to the interface 6 (perpendicular to the plane of the interface) and hence to the waveguide core 3.

Thus, in order to make use of the reference plane 6, the substrate on which the silica waveguide 3 is formed and that which carries the optical component to be aligned therewith are etched with inter-engaging features.

The projections 8 are preferably micro-machined, eg in a silicon wafer, by an etching process so can be formed with sub-micron accuracy.

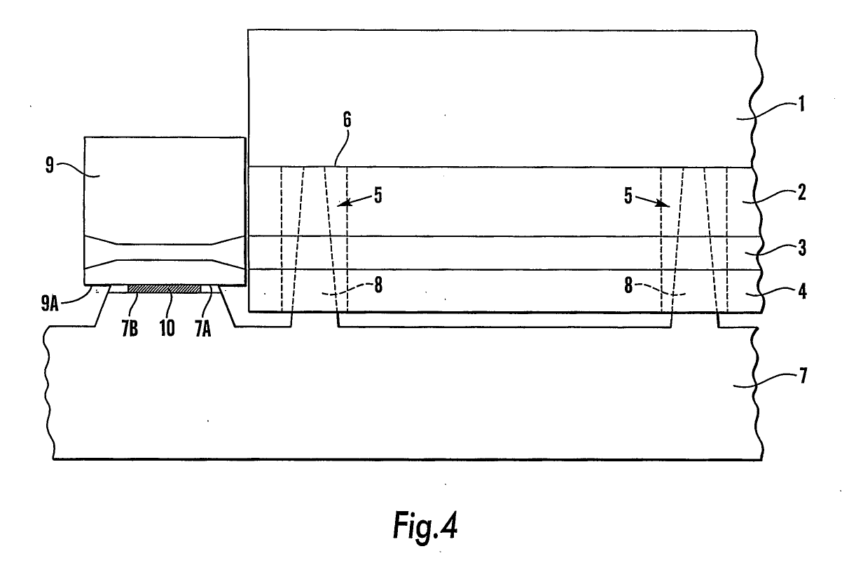

FIG. 4 shows the waveguide component mounted on the support substrate 7 on which an optical component 9 is mounted. The optical component 9 is mounted such that it has a reference surface 9A in direct contact with a reference surface 7A of the support substrate 7. This may be achieved by creating a well 7B in the substrate 7 beneath a central portion of the optical component 9 to contain solder or adhesive 10 used to attach the optical component to the support substrate 7 so there is no solder or adhesive between the reference surfaces 8A, 7A on the optical component 9 and the support substrate 7. The position of the optical mode of the optical component 9 is then accurately defined (in height) by the manufacturing tolerance of the material of which the optical component is formed. In the case of an active optical component, e.g. a laser diode or an amplifier, this tolerance is typically <0.1 microns.

It should be noted that, in practice, the relative dimensions of the components may differ from those shown in FIG. 3. The depth of the recesses 5 is typically around 30-40 microns and the projections 8 will be of similar length. The width of the recess 5 has little effect on the alignment and may vary considerably depending on the function of the overall device to be manufactured, e.g. from 2 to 200 microns. Where it is desirable to maintain the silica waveguide component at a different temperature to the support substrate 7, the width of the projections 8 recesses 5 may be minimised to reduce the contact area and thus the thermal transfer between the two components. Conversely, where a good thermal path between waveguide component and optical component is desirable, the width of the recesses 5 and the projections 8 may be maximised to provide the largest contact area possible so long as the recesses 5 do not approach so close to the waveguide core 3 as to affect the optical mode profile. The recesses 5 preferably have a width only slightly greater than the width of the projections 8 so as to minimise the amount of material that has to be etched away to form the recesses 5.

The contact between the projections 8 and the recesses 5 should be free of adhesive or solder to ensure that the height accuracy is dependent only on the manufacturing tolerances previously described, and not on the bondline of an adhesive. This may be achieved by using a low viscosity adhesive (not shown) in the recesses and applying a suitable pressure to the components such that a zero thickness bondline is formed and the adhesive is displaced to form a fillet between the sidewalls of the projection 8 and the recess 5. Alternatively, adhesive may be placed away from the projections 8 and recesses 5, between the cladding layer 4 of the silica waveguide and the surface of the supporting substrate 7.

Preferably, sufficient projections 8 and recesses 5 are provided to stably support the silica on silicon waveguide component on the support substrate 7 (or vice versa). Typically, three or four projections 8 would be provided in a triangular or rectangular arrangement.

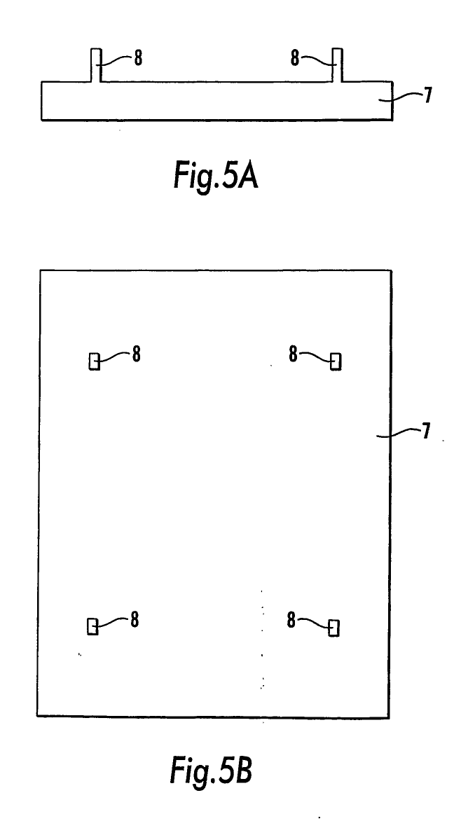

FIGS. 5A and 5B show a support substrate 7 having four projections 8 in a rectangular arrangement. Other arrangements are, however, possible depending on the shape of the projections 8 and/or recesses 5.

As shown in FIG. 4, the optical component 9 to be aligned with the silica on silicon waveguide may be mounted on the supporting substrate 7 to which the silica on silicon chip is mounted. The optical component is mounted accurately on the support substrate, e.g. as described above, so its mounting on the substrate 7 has no significant effect on the accuracy of its location relative to the core 3 of the silica waveguide. However, in other cases, the optical component 9 itself may be provided with the projections 8 and be mounted directly to the silica on silicon chip.

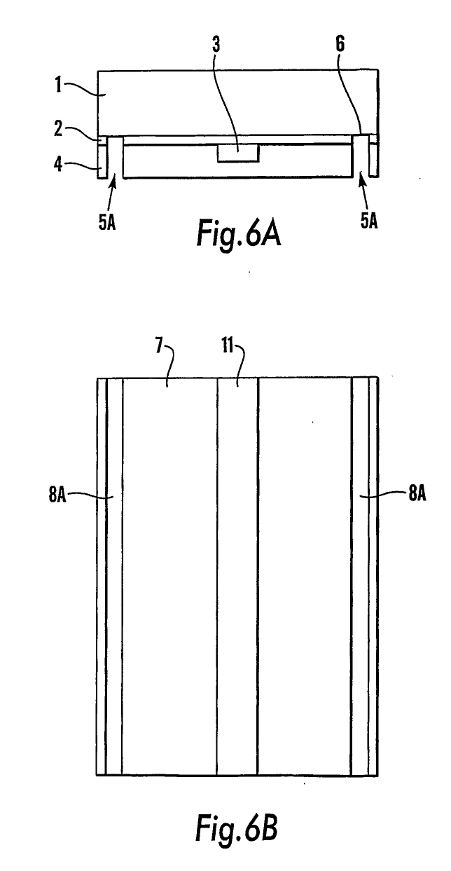

FIG. 6 illustrates an extension of the above concept which also provides for passive alignment in two axes, one perpendicular to the plane of the chips (as above) and the other parallel to the plane of the chip. FIG. 6A shows an end view of a modified waveguide component similar to that of FIG. 2 but, as shown in the underneath view In FIG. 6B, the recesses 5A are etched in the form of elongate grooves 5A. A device such as that shown in FIGS. 5A and 5B may be mounted with two projections 8 in each groove 5A. Alternatively, projections in the form of elongate rails 8A as shown in FIG. 6B may be used. The grooves 5A and projections 8A thus locate the two components relative to each other along an axis parallel to the planer of the chips and perpendicular to their lengths leaving only the position along one axis (parallel to the length of the grooves 5A) to be aligned actively. This axis preferably corresponds to the optical axis, as alignment tolerances are most relaxed on this axis.

In some cases, the component can be aligned with the waveguide along the optical axis by butting up against an end face of the waveguide. FIG. 6B shows a waveguide 11 formed on the support substrate 7 for aligning with the core 3 of the silica on silicon waveguide shown in FIG. 6A. Thus, in this case, the optical component is another waveguide, e.g. a silicon waveguide.

The etch in the silica waveguide to form the recesses 5 can be carried out accurately by using an etchant with a high selectivity between silica (SiO₂) and silicon (Si), while the support substrate can be etched to form the projections 8 either with a wet etch or by reactive ion etching (RIE) to produce features at the correct height (with sub-micron tolerance) to support the substrate at the desired height relative to the waveguide core 3.

This accurate height reference thus enables a silica on silicon waveguide to be passively aligned in the vertical direction to an optical component, such as an active device, (whose optical mode height is well controlled) supported on the same substrate. This remains true regardless of the order in which the components are assembled onto the substrate. Typically, the substrate would be etched in a multistage process to produce a reference plane for the active device and the projections to mate with the etched holes in the silica device.

The principle of using an accurate reference plane for alignment can be extended to allow alignment of more than two components with a silica on silicon waveguide.

The arrangements described above thus enable an assembly consisting of one or more active optical components and one or more silica on silicon waveguides to be produced by mounting the components on a support substrate and using partially or totally passive alignment techniques rather than complex multi-axis active alignment procedures.

Optical components which can be mounted in this way include a semiconductor optical amplifier (SOA), or an array of semiconductor amplifiers, e.g. mounted on a plinth which has been micro-machined to provide accurate positioning of the SOAs thereon and with projections 8 for mounting the plinth relative to the silica on silicon waveguide.

The above description relates to silica on silicon waveguides but the invention can also be used with other waveguides comprising a core and cladding of a first material (although the core and cladding may be doped differently to provide them with different refractive indices) supported on a substrate of another material. The two materials should provide good etch selectivity so that recesses can be etched down to the interface therebetween with high accuracy.

Examples of such other materials are cross-linked resin systems, linear and branched polymers and copolymers, which have suitable refractive indices and transmission losses, or combinations of these materials with glasses or semiconductors as substrates.

1. An optical coupling between an optical component and a waveguide, the waveguide comprising a core and cladding layer of a first material supported on a first substrate of a second material, the core being spaced from the first substrate by a known distance, wherein one or more recesses are formed through the cladding layer to the first substrate and the optical component comprises, or is mounted on a second substrate which comprises, one or more projections of known length, each projection being located in contact with the first substrate within a respective recess so that the optical component is positioned in a known location relative to the first substrate and hence to the waveguide core.

2. An optical coupling as claimed in claim 1 in which the core is spaced from the first substrate by a distance known to sub-micron accuracy.

3. An optical coupling as claimed in claim 1 in which one or more of the recesses are made by etching through the cladding layer, the second material providing an etch stop layer.

4. An optical coupling as claimed in claim 1 in which the length of the one or more projections is known to sub-micron accuracy, the one or more projections being formed by a micro-machining process, preferably an etching process.

5. An optical coupling as claimed in claim 1 in which the one or more recesses have a depth in the range of 30-40 microns.

6. An optical coupling as claimed in claim 1 comprising three or four projections in a triangular or rectangular arrangement.

7. An optical coupling as claimed in claim 1 in which the one or more recesses and/or the one or more projections are shaped to provide passive alignment of the optical component with the waveguide core in a direction parallel to the plane of the layers of the device, preferably perpendicular to the optic axis of the waveguide.

8. An optical coupling as claimed in claim 7 in which one or more of the recesses is in the form of an elongate groove.

9. An optical coupling as claimed in claim 1 in which the optical component is passively aligned in a direction along the optical axis of the waveguide by butting up against an end face of the waveguide.

10. An optical coupling as claimed in claim 1 in which the waveguide is a silica on silicon waveguide comprising a silica core and a silica cladding layer supported on an oxide layer over a silicon substrate.

11. An optical coupling as claimed in claim 1 in which the optical component is mounted on a second substrate which is mounted on the first substrate by means of the one or more recesses and one or more projections.

12. An optical coupling as claimed in claim 11 in which the second substrate comprises a silicon chip.

13. An optical coupling as claimed in claim 1 in which the optical component comprises a laser or a semiconductor optical amplifier.

14. An optical device comprising a plurality of couplings as claimed in claim 1 between a plurality of optical components and a plurality of waveguides, each of the waveguides being on the same substrate.

15. (Cancelled)

16. A method of coupling an optical component with a waveguide, comprising the steps of:
fabricating a waveguide comprising a core and a cladding layer of a first material supported on a first substrate of a second material, the core being spaced from the first substrate by a known distance,
forming one or more recesses through the cladding layer to the first substrate;
fabricating an optical component, or a second substrate on which the component is or is to be mounted, with one or more projections of known length; and
locating each projection in contact with the first substrate within a respective recess so the optical component is positioned in a known location relative to the first substrate and hence to the waveguide core.

17. A method as claimed in claim 16 in which the waveguide is a silica on silicon waveguide comprising a silica core and a silica cladding layer supported on an oxide layer over a silicon substrate.

18. (Cancelled).
